(19) United States
(12) Patent Application Publication
(10) Pub. No.: US 2026/0004801 A1
(43) Pub. Date: Jan. 1, 2026

(54) Voice Activity Detection Method, Electronic Device, and Non-Transitory Readable Storage Medium

(71) Applicant: VIVO MOBILE COMMUNICATION CO., LTD., Dongguan (CN)

(72) Inventor: Yong Zhang, Dongguan (CN)

(21) Appl. No.: 19/320,095

(22) Filed: Sep. 5, 2025

Related U.S. Application Data
(63) Continuation of application No. PCT/CN2024/079075, filed on Feb. 28, 2024.

(30) Foreign Application Priority Data
Mar. 6, 2023 (CN) 202310205479.1

(51) Int. Cl. G10L 25/78; G06N 3/0464; G10L 25/30

(52) U.S. Cl. CPC G10L 25/78; G06N 3/0464; G10L 25/30; G10L 2025/783

(57) ABSTRACT

A voice activity detection method includes; obtaining a target audio feature of a target audio signal, inputting the target audio feature into a first network layer of a target model to obtain a first feature map including N first channels, inputting the first feature map into a second network layer of the target model to obtain a second feature map including N second channels, and outputting a voice activity detection category based on the second feature map. Each first channel includes one target feature matrix, and each target feature matrix is obtained by the first network layer by performing high-level feature extraction on the target audio feature. Each second channel corresponds to one first channel, each second channel includes one target feature value, and each target feature value is obtained by the second network layer by performing temporal modeling on a corresponding target feature matrix.

### CROSS-REFERENCE TO RELATED APPLICATIONS

This application is a Bypass Continuation Application of International Patent Application No. PCT/CN2024/079075 filed Feb. 28, 2024, and claims priority to Chinese Patent Application No. 202310205479.1 filed Mar. 6, 2023, the disclosures of which are hereby incorporated by reference in their entireties.

### BACKGROUND OF THE INVENTION

### Field of the Invention

This application pertains to the field of audio processing technologies, and in particular, relates to a voice activity detection method, an electronic device, and a non-transitory readable storage medium.

### Description of Related Art

An electronic device may perform voice activity detection on an audio signal to distinguish a speech signal from a non-speech (such as noise or silence) signal in the audio signal, so that the electronic device can encode and transmit only the speech signal, to reduce an amount of audio data to be transmitted and improve utilization of a transmission channel. Generally, an electronic device may extract features of an audio signal (such as a time domain feature and a frequency domain feature) and distinguish a speech signal from a non-speech signal based on the features.

### SUMMARY OF THE INVENTION

According to a first aspect, an embodiment of this application provides a voice activity detection method. The method includes: obtaining a target audio feature of a target audio signal; inputting the target audio feature into a first network layer of a target model to obtain a first feature map, where the first feature map includes N first channels, each first channel includes one target feature matrix, each target feature matrix is obtained by the first network layer by performing high-level feature extraction on the target audio feature, and N is a positive integer greater than 1; inputting the first feature map into a second network layer of the target model to obtain a second feature map, where the second feature map includes N second channels, each second channel corresponds to one first channel, each second channel includes one target feature value, each target feature value is obtained by the second network layer by performing temporal modeling on a corresponding target feature matrix, and each target feature value is used to represent a context feature of the corresponding target feature matrix; and outputting a voice activity detection category based on the second feature map.

According to a second aspect, an embodiment of this application provides a voice activity detection apparatus. The voice activity detection apparatus includes an obtaining module, a processing module, and an output module. The obtaining module is configured to obtain a target audio feature of a target audio signal; the processing module is configured to: input the target audio feature obtained by the obtaining module into a first network layer of a target model to obtain a first feature map, where the first feature map includes N first channels, each first channel includes one target feature matrix, each target feature matrix is obtained by the first network layer by performing high-level feature extraction on the target audio feature, and N is a positive integer greater than 1; and input the first feature map into a second network layer of the target model to obtain a second feature map, where the second feature map includes N second channels, each second channel corresponds to one first channel, each second channel includes one target feature value, each target feature value is obtained by the second network layer by performing temporal modeling on a corresponding target feature matrix, and each target feature value is used to represent a context feature of the corresponding target feature matrix; and the output module is configured to output a voice activity detection category based on the second feature map obtained by the processing module after the input.

According to a third aspect, an embodiment of this application provides an electronic device. The electronic device includes a processor and a memory. The memory stores a program or instructions executable on the processor. When the program or instructions are executed by the processor, the steps of the method according to the first aspect are implemented.

According to a fourth aspect, an embodiment of this application provides a non-transitory readable storage medium. The non-transitory readable storage medium stores a program or instructions. When the program or instructions are executed by a processor, the steps of the method according to the first aspect are implemented.

According to a fifth aspect, an embodiment of this application provides a chip. The chip includes a processor and a communication interface. The communication interface is coupled to the processor. The processor is configured to run a program or instructions to implement the method according to the first aspect.

According to a sixth aspect, an embodiment of this application provides a computer program product. The program product is stored in a non-transitory storage medium. The program product is executed by at least one processor to implement the method according to the first aspect.

### BRIEF DESCRIPTION OF THE DRAWINGS

FIG. 1 is a first flowchart of a voice activity detection method according to an embodiment of this application;

FIG. 2 is a second flowchart of a voice activity detection method according to an embodiment of this application;

FIG. 3 is a first schematic diagram of a network structure of a target model according to an embodiment of this application;

FIG. 4 is a schematic diagram of a network structure of any residual network unit with a first residual network according to an embodiment of this application;

FIG. 5 is a second schematic diagram of a network structure of a target model according to an embodiment of this application;

FIG. 6 is a third flowchart of a voice activity detection method according to an embodiment of this application;

FIG. 7 is a third schematic diagram of a network structure of a target model according to an embodiment of this application;

FIG. 8 is a fourth flowchart of a voice activity detection method according to an embodiment of this application;

FIG. 9 is a fifth flowchart of a voice activity detection method according to an embodiment of this application;

FIG. 10 is a schematic diagram of a structure of a voice activity detection apparatus according to an embodiment of this application;

FIG. 11 is a schematic diagram of a structure of an electronic device according to an embodiment of this application; and

FIG. 12 is a schematic diagram of a hardware structure of an electronic device according to an embodiment of this application.

### DESCRIPTION OF THE INVENTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the numbers used in this way are interchangeable in appropriate circumstances, so that the embodiments of this application can be implemented in other orders than the order illustrated or described herein. In addition, objects distinguished by “first”, “second”, and the like usually fall within one class, and a quantity of objects is not limited. For example, there may be one or more first objects. In addition, the term “and/or” in the specification and claims indicates at least one of connected objects, and the character “/” generally represents an “or” relationship between associated objects.

A voice activity detection method and apparatus, an electronic device, and a non-transitory readable storage medium provided in embodiments of this application are hereinafter described in detail by using some embodiments and application scenarios thereof with reference to the accompanying drawings.

Generally, an electronic device may perform voice activity detection (VAD) on an audio signal to distinguish a speech signal from a non-speech (such as noise or silence) signal in the audio signal, so that the electronic device can encode and transmit only the speech signal, to reduce an amount of audio data to be transmitted and improve utilization of a transmission channel. Generally, an electronic device may extract features (such as a time domain feature and a frequency domain feature) of an audio signal to be transmitted, use a VAD algorithm to obtain an audio feature value through calculation based on the time domain feature and the frequency domain feature, and distinguish the audio signal as a speech signal or a non-speech signal based on a magnitude relationship between the audio feature value and a preset value. However, because the time domain feature and the frequency domain feature of the audio signal are not readily distinguishable, and the VAD algorithm assumes stationarity of noise, the time domain feature of the audio signal is greatly affected by noise when the electronic device is located in an environment with a low signal-to-noise ratio, and the VAD algorithm cannot accurately obtain the audio feature value through calculation. Consequently, the electronic device may be unable to distinguish a speech signal from a non-speech signal based on the time domain feature and the frequency domain feature of the audio signal. This may cause a situation in which the electronic device cannot distinguish the audio signal as a speech signal or a non-speech signal based on the time domain feature and the frequency domain feature of the audio signal. Therefore, accuracy of voice activity detection performed by the electronic device is poor.

However, in an embodiment of this application, an electronic device may first obtain an audio feature (such as a filter bank (Fbank) feature) of an audio signal to be transmitted, and then input the Fbank feature into a first network layer of a neural network model, so that the first network layer can perform high-level feature extraction on the Fbank feature to obtain a plurality of feature matrices, so as to obtain a feature map (each of channels included in the feature map includes one feature matrix), and input the feature map into a second network layer of the neural network model, so that the second network layer can perform temporal modeling on the feature map to obtain a plurality of feature values (each feature value is used to represent a context feature of a corresponding feature matrix), so as to obtain another feature map (each of channels included in the other feature map includes one feature value), so that the electronic device can output a voice activity detection category based on the other feature map. It may be understood that because the electronic device can input the Fbank feature of the audio signal to be transmitted into the neural network model, the first network layer can perform high-level feature extraction on the Fbank feature to obtain a plurality of feature matrices with higher dimensions, that is, obtain the plurality of feature matrices with higher robustness and distinguishability, and the second network layer can perform temporal modeling on the plurality of feature matrices, to obtain the plurality of feature values used to represent context features of the plurality of feature matrices, that is, obtain the plurality of feature values with higher robustness and distinguishability. In this way, the electronic device can accurately distinguish the audio signal as a speech signal or a non-speech signal based on the plurality of feature values with higher robustness and distinguishability, instead of using a VAD algorithm that assumes stationarity of noise, and performing calculation based on a time domain feature and a frequency domain feature with lower robustness and distinguishability, thereby improving accuracy of voice activity detection performed by the electronic device.

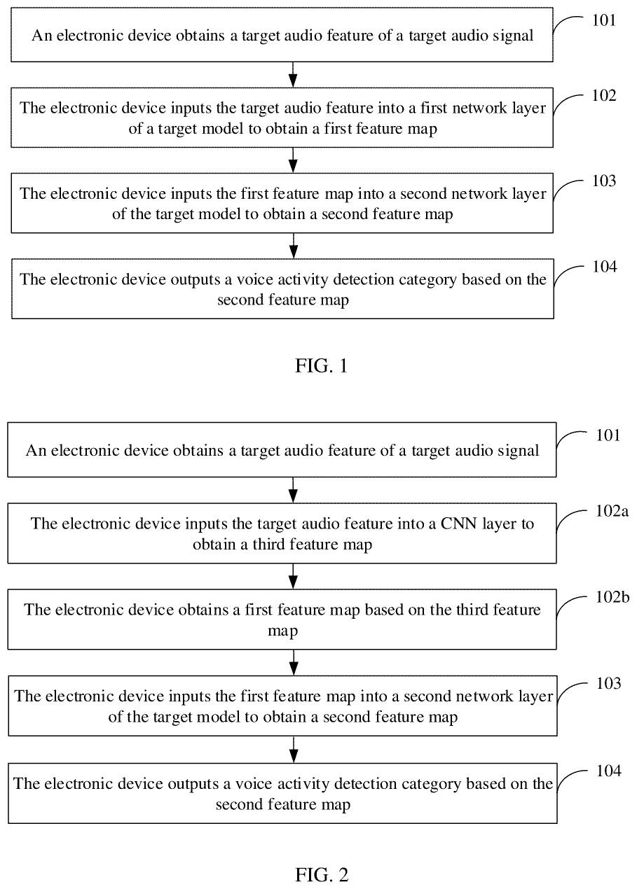

FIG. 1 is a flowchart of a voice activity detection method according to an embodiment of this application. As shown in FIG. 1, the voice activity detection method provided in this embodiment of this application may include the following step 101 to step 104.

Step 101: An electronic device obtains a target audio feature of a target audio signal.

In one scenario, when the electronic device needs to transmit an audio signal, the electronic device may determine a target audio signal from the audio signal and obtain a target audio feature of the target audio signal.

In another scenario, when the electronic device needs to perform speech recognition on an audio signal, the electronic device may determine a target audio signal from the audio signal and obtain a target audio feature of the target audio signal.

It may be understood that the target audio signal may be an audio signal in an audio signal to be transmitted (or an audio signal on which speech recognition needs to be performed by the electronic device).

Optionally, in this embodiment of this application, the target audio signal may include one or more frames of audio signals.

In this embodiment of this application, the target audio feature is used to represent the audio feature of the target audio signal.

Optionally, in this embodiment of this application, the target audio feature may include at least one of the following: an Fbank feature, a Mel frequency cepstral coefficient (MFCC), a perceptual linear predictive (PLP) feature, a fast Fourier transform (FFT) spectral feature, or the like. It should be noted that a person skilled in the art may autonomously set the feature included in the target audio feature based on a requirement. This is not limited in this application.

Optionally, in this embodiment of this application, if the target audio signal includes one frame of audio signal, the electronic device may directly extract an audio feature of the frame of audio signal to obtain the target audio feature, or may extract audio features of the frame of audio signal and audio signals adjacent to the frame of audio signal to obtain the target audio feature.

It should be noted that the “audio signals adjacent to the frame of audio signal” may be understood as: h frames of audio signals located before the frame of audio signal in the foregoing audio signal, and/or p frames of audio signals located after the frame of audio signal in the foregoing audio signal, where h and p are both positive integers.

Step 102: The electronic device inputs the target audio feature into a first network layer of a target model to obtain a first feature map.

In this embodiment of this application, the target model may be a neural network model.

Optionally, in this embodiment of this application, the first network layer may include at least one of the following: a convolutional layer or a residual network layer. There may be one or more convolutional layers, and one or more residual network layers. The convolutional layer may be a convolutional neural network (CNN) layer.

In a case that there are a plurality of convolutional layers, the plurality of convolutional layers may be connected to each other, and network hyperparameters of the plurality of convolutional layers may be the same or different. The network hyperparameter of the convolutional layer may include at least one of the following: a size of a convolution kernel, a number of output channels generated by convolution, a stride of convolution, or the like.

It should be noted that “the plurality of convolutional layers may be connected to each other” may be understood as: an output layer of each convolutional layer is connected to an input layer of a next convolutional layer.

For example, if the plurality of convolutional layers are connected to each other, an output layer of a first convolutional layer among the plurality of convolutional layers is connected to an input layer of a second convolutional layer, an output layer of the second convolutional layer is connected to an input layer of a third convolutional layer, and so on.

It may be understood that the electronic device may perform high-level feature extraction on the target audio feature by using the convolutional layer, to obtain an audio feature with higher dimensions.

In a case that there are a plurality of residual network layers, the plurality of residual network layers may be connected to each other, and network hyperparameters of the plurality of residual network layers may be the same or different. The network hyperparameter of the residual network layer may be at least one of the following: a size of a convolution kernel, a number of output channels generated by convolution, a stride of convolution, dimensions of an output feature, or the like.

It may be understood that when a network layer of the target model gradually becomes deeper, the target model may have a problem of network degradation in a training process of the target model, resulting in performance degradation of the target model. Therefore, the electronic device can set the residual network layer in the target model, so that the residual network layer can resolve problems of network degradation and gradient vanishing in the training process of the target model by establishing a “skip connection” between a previous layer (such as the convolutional layer) and a subsequent layer (such as a second network layer in the following embodiment), so as to improve gradient back propagation in the training process, thereby improving training efficiency of the model. Moreover, the electronic device may perform high-level feature extraction on the audio feature with higher dimensions by using the residual network layer, to obtain a high-dimensional audio feature.

Optionally, in this embodiment of this application, the electronic device may train the neural network model by using a training speech, to obtain the target model.

The electronic device may first preprocess the training speech to obtain a plurality of framed signals, then perform feature extraction on each framed signal to obtain a feature parameter of each framed signal, and obtain a label of each framed signal by using a manual annotation method (the label indicates that the corresponding framed signal is a speech signal or a non-speech signal). Therefore, the electronic device can input the plurality of framed signals into the neural network model for training, and use the label of each framed signal as annotation data at a top layer of the neural network model for supervised training, and then update a model parameter of the neural network model by using a back propagation algorithm, to obtain the target model.

In this embodiment of this application, the first feature map includes N first channels, each of the N first channels includes one target feature matrix, each of N target feature matrices is obtained by the first network layer by performing high-level feature extraction on the target audio feature, and N is a positive integer greater than 1.

It may be understood that the first feature map may be an audio feature output by the first network layer, and the target feature matrix included in each first channel of the first feature map is obtained by performing high-level feature extraction on the target audio signal, that is, the target feature matrix included in the N first channels is a high-dimensional audio feature of the target audio signal, that is, the first feature map is a high-dimensional audio feature of the target audio signal.

The following describes a structure of the first network layer by using an example.

Optionally, in this embodiment of this application, the first network layer includes a CNN layer. With reference to FIG. 1, as shown in FIG. 2, the foregoing step 102 may be implemented by the following step 102a and step 102b

Step 102a: The electronic device inputs the target audio feature into the CNN layer to obtain a third feature map.

It may be understood that in this embodiment, the convolutional layer is the CNN layer.

The CNN layer may be a convolutional layer, and a dimension of the convolutional layer may be at least one dimension.

For example, the CNN layer may be a convolutional two-dimensional (Convolutional Two-Dimensional-1, Conv2D-1) layer. Parameters of the CNN layer include a size of a convolution kernel, a number of output channels generated by convolution, and a stride of convolution.

For example, the size of the convolution kernel of the CNN layer may be 3×3, the number of output channels generated by convolution of the CNN layer may be 16, and the stride of convolution of the CNN layer may be (1, 1).

In this embodiment of this application, the third feature map includes Q third channels, each of the Q third channels includes one first feature matrix, each of Q first feature matrices is obtained by the CNN layer by performing a convolution operation on the target audio feature, and Q is a positive integer greater than 1.

For example, elements in each of the Q first feature matrices are the same, or elements in some first feature matrices are the same, or elements in each first feature matrix are different.

In this embodiment of this application, after the electronic device inputs the target audio feature into the CNN layer, the electronic device may obtain the Q first feature matrices output by the CNN layer, so that the electronic device can map each first feature matrix to one third channel to obtain the third feature map.

It may be understood that the number Q of third channels included in the third feature map is the same as the number of output channels generated by convolution of the CNN layer. For example, Q may be equal to 16.

For example, assuming that the dimensions of the target audio feature are K×8×1 dimensions and that the number of output channels generated by convolution of the CNN layer is 16, after the target audio feature is input into the CNN layer, the CNN layer may perform a convolution operation on the K×8×1-dimensional audio feature, and output a K×8×1-dimensional audio feature from an output channel generated by convolution of the CNN layer, thereby obtaining a K×8×16-dimensional audio feature. Therefore, the electronic device can map each K×8×1-dimensional audio feature to one third channel to obtain the third feature map.

Step 102b: The electronic device obtains the first feature map based on the third feature map.

In this embodiment of this application, the electronic device may directly perform feature extraction on the third feature map to obtain the first feature map. Alternatively, the electronic device may input the third feature map into the residual network layer to obtain the first feature map.

In this way, it can be learned that, because the electronic device can input the target audio feature into the CNN layer to increase the number of channels corresponding to the target audio feature, the third feature map with higher dimensions can be obtained, that is, the third feature map with higher robustness can be obtained. Therefore, the electronic device can obtain the first feature map with higher robustness based on the third feature map. This can reduce impact of noise on the first feature map when the electronic device is in an environment with a low signal-to-noise ratio. In this way, the electronic device can accurately distinguish a speech signal from a non-speech signal based on the first feature map.

Moreover, the CNN layer has characteristics of weight value sharing and local receptive fields, that is, the CNN layer has a characteristic of translation invariance. Therefore, robustness of the third feature map can be improved, that is, robustness of the first feature map can be improved.

Optionally, in this embodiment of this application, the first network layer further includes at least one residual network layer connected in sequence. The foregoing step 102b may be implemented by the following step 102b1.

Step 102b1: The electronic device inputs the third feature map into the at least one residual network layer to obtain the first feature map.

In this embodiment of this application, the first feature map is obtained by the at least one residual network layer by sequentially performing an operation on the third feature map, and a network hyperparameter of each of the at least one residual network layer is different.

It may be understood that the electronic device may input the third feature map into a first residual network layer of the at least one residual network layer, so that residual network units included in the first residual network layer can process the third feature map in sequence, and input the processed feature map to a second residual network layer, and so on, to obtain the N target feature matrices. In this way, the electronic device can map each target feature matrix to one first channel to obtain the first feature map.

Understandably, an input layer of the first residual network layer of the at least one residual network layer is connected to an output layer of the CNN layer, an output layer of the first residual network layer is connected to an input layer of the second residual network layer, an output layer of the second residual network layer is connected to an input layer of a third residual network layer, and so on.

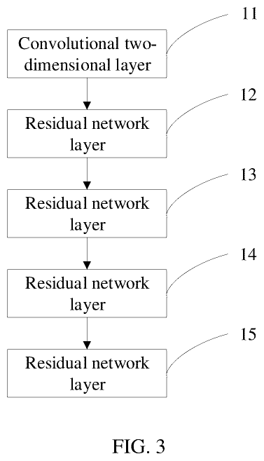

For example, FIG. 3 is a schematic diagram of a possible network structure of a target model according to an embodiment of this application. The target model may include a first network layer and a second network layer. As shown in FIG. 3, the first network layer includes a CNN layer (for example, a convolutional two-dimensional layer 11) and at least one residual network layer (for example, a residual network layer 12, a residual network layer 13, a residual network layer 14, and a residual network layer 15). An output layer of the convolutional two-dimensional layer 11 is connected to an input layer of the residual network layer 12, an output layer of the residual network layer 12 is connected to an input layer of the residual network layer 13, an output layer of the residual network layer 13 is connected to an input layer of the residual network layer 14, and an output layer of the residual network layer 14 is connected to an input layer of the residual network layer 15, so that the electronic device can input the target audio features into the convolutional two-dimensional layer 11, to obtain the first feature map output by an output layer of the residual network layer 15.

For each of the at least one residual network layer, one residual network layer may be a squeeze-and-excitation (SE)-residual network (ResNet) layer. The one residual network layer may include at least two residual network units connected to each other.

A network hyperparameter of the one residual network layer may be different from that of another residual network layer. The other residual network layer is a residual network layer in the at least one residual network layer except the one residual network layer. Network hyperparameters of residual networks in the residual network units included in the one residual network layer may be the same.

For example, assuming that a feature corresponding to the third feature map is H×W×16 (that is, a first feature matrix (that is, H×W) included in each third channel), and that the at least one residual network layer includes four residual network layers, each of which includes two residual network units, network hyperparameters of each of the four residual network layers are different, and network hyperparameters of residual networks in residual network units included in each residual network layer are the same. For example, the network hyperparameters of the four residual network layers are shown in Table 1.

TABLE 1
Network hyperparameter table of the residual network layer

| Layer name | Layer structure | Output feature |
|---|---|---|
| Input | — | H × W × 16 |
| SE-ResNet-1 | $[ \begin{matrix}3 \times 3 , 16 \\ 3 \times 3 , 16\end{matrix} ] \times 2 , stride = ( 1 , 1 )$ | H × W × 16 |
| SE-ResNet-2 | $[ \begin{matrix}3 \times 3 , 32 \\ 3 \times 3 , 32\end{matrix} ] \times 2 , stride = ( 2 , 2 ) or stride = ( 1 , 1 )$ | $\frac{H}{2} \times \frac{W}{2} \times 32$ |
| SE-ResNet-3 | $[ \begin{matrix}3 \times 3 , 64 \\ 3 \times 3 , 64\end{matrix} ] \times 2 , stride = ( 2 , 2 ) or stride = ( 1 , 1 )$ | $\frac{H}{4} \times \frac{W}{4} \times 64$ |
| SE-ResNet-4 | $[ \begin{matrix}3 \times 3 , 128 \\ 3 \times 3 , 128\end{matrix} ] \times 2 , stride = ( 2 , 2 ) or stride = ( 1 , 1 )$ | $\frac{H}{8} \times \frac{W}{8} \times 128$ |

The input layer is connected to the output layer of the CNN layer, and a feature of the input layer is H×W×16.

The SE-ResNet-1 is a first residual network layer among the four residual network layers. An input layer of the SE-ResNet-1 is connected to the input layer, the SE-ResNet-1 includes two residual network units, and the two residual network units included in the SE-ResNet-1 are connected to each other. A size of a convolution kernel of a residual network in each residual network unit included in the SE-ResNet-1 is 3×3, and a number of output channels generated by convolution is 16. A stride of convolution of the residual network in each residual network unit included in the SE-ResNet-1 is (2, 2) or (1, 1). After processing at the SE-ResNet-1, an output feature is H×W×16.

The SE-ResNet-2 is a second residual network layer among the four residual network layers. An input layer of the SE-ResNet-2 is connected to an output layer of the SE-ResNet-1, the SE-ResNet-2 includes two residual network units, and the residual network units included in the SE-ResNet-2 are connected to each other. A size of a convolution kernel of a residual network in each residual network unit included in the SE-ResNet-2 is 3×3, and a number of output channels generated by convolution is 32. A stride of convolution of the residual network in each residual network unit included in the SE-ResNet-2 is (2, 2) or (1, 1). After processing at the SE-ResNet-2, an output feature is

$$\frac{H}{2} \times \frac{W}{2} \times 32.$$

The SE-ResNet-3 is a third residual network layer among the four residual network layers. An input layer of the SE-ResNet-3 is connected to an output layer of the SE-ResNet-2, the SE-ResNet-3 includes two residual network units, and the two residual network units included in the SE-ResNet-3 are connected to each other. A size of a convolution kernel of a residual network in each residual network unit included in the SE-ResNet-3 is 3×3, and a number of output channels generated by convolution is 64. A stride of convolution of the residual network in each residual network unit included in the SE-ResNet-3 is (2, 2) or (1, 1). After processing at the SE-ResNet-3, an output feature is

$$\frac{H}{4} \times \frac{W}{4} \times 64.$$

The SE-ResNet-4 is a fourth residual network layer among the four residual network layers. An input layer of the SE-ResNet-4 is connected to an output layer of the SE-ResNet-3, the SE-ResNet-4 includes two residual network units, and the two residual network units included in the SE-ResNet-4 are connected to each other. A size of a convolution kernel of a residual network in each residual network unit included in the SE-ResNet-4 is 3×3, and a number of output channels generated by convolution is 128. A stride of convolution of the residual network in each residual network unit included in the SE-ResNet-4 is (2, 2) or (1, 1). After processing at the SE-ResNet-4, an output feature is

$$\frac{H}{8} \times \frac{W}{8} \times 128.$$

In this way, it can be learned that, because at least one residual network layer may be arranged in the first network layer, a problem of network degradation caused by the target model having more network layers can be avoided, and performance degradation of the target model can be avoided.

Certainly, to enhance a feature representation capability of the first feature map, an SE unit may also be arranged in each residual network layer, so that features can be adjusted channel by channel. The following uses any residual network layer as an example for description.

Optionally, in this embodiment of this application, the first residual network layer includes a residual network and an SE unit; and the first residual network layer is any one of at least one residual network layer. The foregoing step 102b1 may be implemented by the following step 102b1a to step 102b1d.

Step 102b1a: The electronic device inputs a fourth feature map into the residual network to obtain a fifth feature map.

In this embodiment of this application, the first residual network layer includes at least two residual network units, and any residual network unit includes a residual network and an SE unit. This embodiment of this application is described by using any residual network unit as an example.

In this embodiment of this application, the fourth feature map is a feature map output by a residual network layer previous to the first residual network layer in the at least one residual network layer; and the fifth feature map is obtained by performing an operation on the fourth feature map by the residual network.

A number of channels included in the fourth feature map and a number of channels included in the fifth feature map may be the same, and the channels of the fourth feature map may be in a one-to-one correspondence with the channels of the fifth feature map.

For example, in a case that the first residual network layer is the first residual network layer (for example, SE-ResNet-1) of the at least one residual network layer, a residual network layer previous to the SE-ResNet-1 is the foregoing input layer. In a case that the first residual network layer is the second residual network layer (for example, SE-ResNet-2) of the at least one residual network layer, a residual network layer previous to the SE-ResNet-2 is the foregoing SE-ResNet-1.

In this embodiment of this application, the residual network includes at least two first convolutional layers, at least two batch normalization (BN) layers, and a rectified linear unit (ReLU) layer, so that the residual network can use a first algorithm to obtain the fifth feature map through calculation based on the fourth feature map.

Each first convolutional layer may be a convolutional two-dimensional layer.

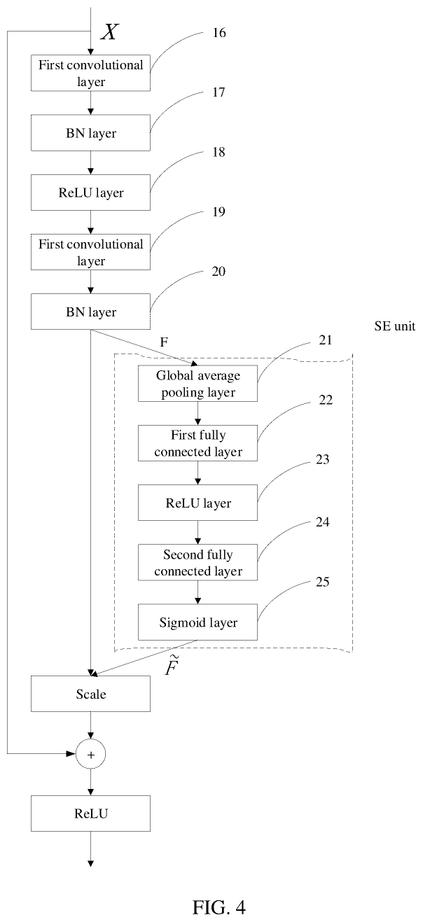

For example, FIG. 4 is a schematic diagram of a network structure of any residual network unit with a first residual network. The first residual network includes a residual network and an SE unit. The residual network includes two first convolutional layers, two BN layers, and a ReLU layer. As shown in FIG. 4, an output layer of a first convolutional layer 16 of the two first convolutional layers may be connected to an input layer of a first BN layer 17 of the two BN layers, and an output layer of the first BN layer 17 may be connected to an input layer of a ReLU layer 18. An output layer of the ReLU layer 18 may be connected to an input layer of a second first convolutional layer 19 of the two first convolutional layers, and an output layer of the second first convolutional layer 19 may be connected to a second BN layer 20 of the two BN layers.

The first algorithm may be: F=BN(Conv(ReLU(BN(Conv(X))))).

Herein, X is the fourth feature map and F is the fifth feature map.

In this embodiment of this application, a core module of the residual network is a convolution kernel of the first convolutional layer. The convolution kernel enables the residual network to construct a feature by fusing spatial and channel information in a local receptive field of each layer.

Step 102b1b: The electronic device inputs the fifth feature map into the SE unit to obtain a first weight value.

In this embodiment of this application, the first weight value includes a second weight value corresponding to each channel included in the fifth feature map, and each second weight value is used to represent a weight of a corresponding channel for audio signal classification.

For example, if a second weight value is higher, it may be considered that a feature included in a channel corresponding to the second weight value is more important for audio signal classification.

Optionally, in this embodiment of this application, the fifth feature map includes Z fourth channels, each of the Z fourth channels includes one second feature matrix, each of Z second feature matrices is obtained by the residual network by performing an operation on the fourth feature map, the SE unit includes a first pooling layer and a fully connected layer that are connected to each other, and Z is a positive integer greater than 1. The foregoing step 102b1b may be implemented by the following step 102b1b1 and step 102b1b2.

Step 102b1b1: The electronic device inputs the Z second feature matrices into the first pooling layer to obtain Z first feature values.

It may be understood that the fourth feature map also includes Z channels.

In this embodiment of this application, each of the Z first feature values is obtained by the first pooling layer by performing an operation on a second feature matrix.

With reference to FIG. 4, the first pooling layer may be a global average pooling layer 21.

In this embodiment of this application, the first pooling layer may use a second algorithm to obtain the Z first feature values through calculation based on the Z second feature matrices.

It may be understood that each of the Z first feature values is a channel descriptor of a fourth channel, and that the first pooling layer may aggregate feature mappings of a feature map in a spatial dimension by using the second algorithm, thereby generating a channel descriptor of each fourth channel.

In a case that a second feature matrix is H×W, the second algorithm may be

$${d}_{c} = \frac{1}{H \times W} {\sum }_{i = 1}^{H} {\sum }_{j = 1}^{W} {F}_{c} ( i , j ) .$$

In the algorithm, de represents a first feature value corresponding to a C^{th} fourth channel of the fifth feature map F; C=1, 2, 3, . . . , Z; F_{C} represents a feature of the C^{th} fourth channel of the fifth feature map F; F_{C}(i, j) represents an element in an i^{th} row and a j^{th} column in a second feature matrix included in the C^{th} fourth channel; and i and j are both positive integers.

After obtaining the Z first feature values, the electronic device may combine the Z first feature values into one feature value, and input the feature value into the fully connected layer.

For example, assuming that the Z first feature values include d₁, d₂, . . . , d_{z}, after obtaining d₁, d₂, . . . , d_{z}, the electronic device may combine d₁, d₂, . . . , d_{z} into one feature value D, where D=(d₁, d₂, . . . , d_{z}), and D represents a channel descriptor after information aggregation is performed on all fourth channels of the fifth feature map F.

Step 102b1b2: The electronic device inputs the Z first feature values into the fully connected layer to obtain Z second weight values.

In this embodiment of this application, each of the Z second weight values is obtained by the fully connected layer by performing an operation on one first feature value, and the first weight value includes the Z second weight values.

With reference to FIG. 4, the fully connected layer may include a first fully connected layer 22, a ReLU layer 23, a second fully connected layer 24, and a Sigmoid layer 25. An input layer of the first fully connected layer 22 is connected to an output layer of the first pooling layer (for example, the global average pooling layer 21), an output layer of the first fully connected layer 22 is connected to an input layer of the ReLU layer 23, an output layer of the ReLU layer 23 is connected to an input layer of the second fully connected layer 24, and an output layer of the second fully connected layer 24 is connected to an input layer of the Sigmoid layer 25.

In this embodiment of this application, the fully connected layer may use a third algorithm to obtain the Z second weight values through calculation based on the Z first feature values.

The third algorithm may be S=Sigmoid(ReLu(D×W₁)×W₂).

Herein, W₁ is a weight value of the first fully connected layer,

$${W}_{1} ∈ {R}^{Z \times \frac{Z}{r}} ,$$

R is a constant, Z is a number of channels of the fifth feature map, and r is a compression ratio of the SE unit. Dimensions of the channel descriptor D are reduced from 1×Z to 1×Z/r through the first fully connected layer. W₂ is a weight value of the second fully connected layer, and

$${W}_{2} ∈ {R}^{\frac{Z}{r} \times Z} ,$$

The dimensions of the channel descriptor D are restored from 1×Z/r to 1×Z through the second fully connected layer. S=(S₁, S₂, . . . , S_{z}). S is the first weight value, and S₁, S₂, . . . , S_{z} are the Z second weight values; and Sigmoid( ) represents a Sigmoid activation function, which maps a variable to a value between 0 and 1.

It may be understood that the fully connected layer may use the third algorithm once for each first feature value, to obtain a second weight value through calculation, so that the Z second weight values can be obtained.

Herein, the first fully connected layer may change the Z fourth channels into Z/r fourth channels, and its function is to reduce a calculation amount, and the second fully connected layer may restore the Z/r fourth channels into the Z fourth channels, because the fifth feature map input by the SE unit has C fourth channels.

It may be understood that the foregoing processing procedure is designed into a bottleneck structure, so that the SE unit has more nonlinearity, and can properly fit complex correlation between channels and reduce the calculation amount. Moreover, a normalized attention weight value (second weight value) of each fourth channel may be obtained by using the Sigmoid activation function, where the weight value represents a weight of each fourth channel for audio signal classification.

In this way, it can be learned that, because the electronic device can input the Z second feature matrices into the first pooling layer and input the Z first feature values output by the first pooling layer into the fully connected layer to obtain the Z second weight values used to represent weights of the Z fourth channels of the fifth feature map for audio signal classification, the electronic device can amplify a feature of a useful channel for audio signal classification in the fourth feature map and suppress a feature of a useless channel for audio signal classification in the fourth feature map based on the Z second weight values. Therefore, the feature representation capability of the obtained first feature map can be improved. In this way, the electronic device can accurately output a voice activity detection category based on the first feature map.

Step 102b1c: The electronic device generates a sixth feature map based on the fifth feature map and the first weight value.

In this embodiment of this application, the electronic device may use a fourth algorithm to obtain a third feature matrix through calculation based on the second feature matrix included in each fourth channel and the second weight value corresponding to each fourth channel, so that the electronic device can map each third feature matrix to one fifth channel to obtain the sixth feature map. It may be understood that the sixth feature map includes Z fifth channels.

In this embodiment of this application, the fourth algorithm may be \tilde{F}_{C}=S_{C}F_{C}.

\tilde{F}_{C} is a third feature matrix corresponding to the C^{th} fourth channel, S_{C} is a second weight value corresponding to the C^{th} fourth channel, and F_{C} is a second feature matrix included in the C^{th} fourth channel.

In this embodiment of this application, the electronic device may respectively multiply the Z second weight values by the second feature matrices included in the Z fourth channels to obtain a recalibrated feature map (that is, the sixth feature map), to amplify a feature of a useful (that is, useful for audio signal classification) fourth channel in the fifth feature map, and suppress a feature of a useless (that is, useless for audio signal classification) fourth channel in the fifth feature map.

Step 102b1d: The electronic device obtains a seventh feature map based on the fourth feature map and the sixth feature map, and outputs the seventh feature map.

In this embodiment of this application, the seventh feature map is a feature map input by a residual network layer next to the first residual network layer in the at least one residual network layer.

For each of the Z fifth channels, the electronic device may add a third feature matrix included in a fifth channel to a feature matrix included in a corresponding channel of the fourth feature map to obtain a fourth feature matrix, thereby obtaining Z fourth feature matrices. Then the electronic device may map each fourth feature matrix to one sixth feature map to obtain the seventh feature map by using a ReLU( ) activation function.

In this way, it can be learned that, because the SE unit may also be arranged in the first residual network, the SE unit can be used to obtain a second weight value corresponding to each channel of the fifth feature map, to determine the weight of each channel for audio signal classification in the fifth feature map; and based on the weight of each channel in the fifth feature map, a feature of a useful channel for audio signal classification in the fourth feature map can be amplified, and a feature of a useless channel for audio signal classification in the fourth feature map can be suppressed. Therefore, the feature representation capability of the obtained first feature map can be improved. In this way, the electronic device can accurately output the voice activity detection category based on the first feature map.

Step 103: The electronic device inputs the first feature map into the second network layer of the target model to obtain a second feature map.

In this embodiment of this application, the second feature map includes N second channels, each of the N second channels corresponds to one first channel, each second channel includes one target feature value, each of N target feature values is obtained by the second network layer by performing temporal modeling on a corresponding target feature matrix, and each target feature value is used to represent a context feature of the corresponding target feature matrix.

In this embodiment of this application, the electronic device may input the first feature map to the second network layer, so that the second network layer can perform temporal modeling on the N target feature matrices to obtain the N target feature values used to represent the context features of the N target feature matrices, so as to obtain the second feature map. Therefore, compared with a time domain feature (and/or a frequency domain feature) generally, the second feature map does not assume stationarity of noise. In this way, in an environment with non-stationary noise (such as an environment with a low signal-to-noise ratio), the second feature map still has high robustness and distinguishability, that is, the electronic device can accurately output the voice activity detection category based on the second feature map.

Optionally, in this embodiment of this application, the second network layer includes a long short-term memory network (Long Short-Term Memory, LSTM) layer. The foregoing step 103 may be implemented by the following step 103a.

Step 103a: The electronic device inputs N third feature values into the LSTM layer to obtain N target feature values.

In this embodiment of this application, the N third feature values are in a one-to-one correspondence with the N target feature matrices, and each of the N third feature values is obtained by performing feature aggregation processing on a corresponding target feature matrix.

In this embodiment of this application, each of the N target feature values is obtained by the LSTM layer by performing an operation on one third feature value.

For example, a number of LSTM layers may be set to 1, the LSTM layer may be set as a unidirectional LSTM network, and a number of nodes at an output layer and a hidden layer of the LSTM layer may be set to N (that is, N in the foregoing embodiment).

In this embodiment of this application, the LSTM layer is used to perform temporal modeling on the N third feature values, to fully use time sequence information implied in the target audio feature.

After obtaining the N target feature values, the electronic device may map one target feature value to one second channel to generate the second feature map.

In this way, it can be learned that, because the electronic device can perform temporal modeling on the N third feature values by using the LSTM layer, and obtain the N target feature values used to represent the context features of the N target feature matrices, so as to obtain the second feature map, instead of assuming stationarity of noise, the second feature map still has good robustness and distinguishability in an environment with non-stationary noise (such as an environment with a low signal-to-noise ratio), that is, the electronic device can accurately output the voice activity detection category based on the second feature map.

Optionally, in this embodiment of this application, the second network layer further includes a second pooling layer. Before the foregoing step 103a, the voice activity detection method provided in this embodiment of this application may further include the following step 103b.

Step 103b: The electronic device inputs the N target feature matrices into the second pooling layer to obtain the N third feature values.

In this embodiment of this application, each of the N third feature values is obtained by the second pooling layer by performing feature aggregation processing on one target feature matrix.

It may be understood that each of the N first channels corresponds to one third feature value.

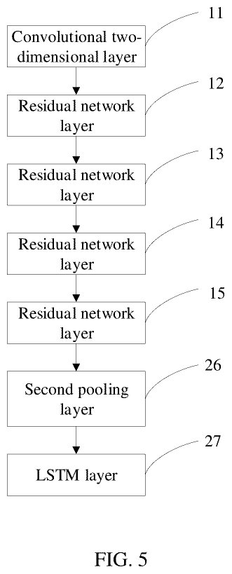

For example, with reference to FIG. 3, as shown in FIG. 5, the target model may further include a second pooling layer 26 and an LSTM layer 27. An input layer of the second pooling layer 26 is connected to the output layer of the residual network layer 15, and an output layer of the second pooling layer 26 is connected to an input layer of the LSTM layer 27, so that the electronic device can input the N target feature matrices into the second pooling layer 26.

In this embodiment of this application, the second pooling layer may be an average pooling layer.

For each of the N target feature matrices, the electronic device may input a target feature matrix into the second pooling layer, so that the second pooling layer can use a fifth algorithm to obtain a third feature value through calculation based on the target feature matrix, thereby obtaining the N third feature values.

In a case that a target feature matrix is H×W, the fifth algorithm may be

$${μ}_{c} = \frac{1}{H \times W} {\sum }_{i = 1}^{H} {\sum }_{j = 1}^{W} {X}_{c} ( i , j ) .$$

Herein, μ_{C} represents a third feature value corresponding to a C^{th} first channel of the first feature map; C=1, 2, 3, . . . , N; X_{C} represents a feature of the C^{th} channel of the first feature map; and X_{C}(i, j) represents an element in an i^{th} row and a j^{th} column of a target feature matrix included in the C^{th} first channel.

After obtaining the N third feature values, the electronic device may combine the N third feature values into one feature value, and input the feature value into the LSTM layer.

For example, assuming that the N third feature values include μ₁, μ₂, . . . , μ_{z}, after obtaining μ₁, μ₂, . . . , μ_{z}, the electronic device may combine μ₁, μ₂, . . . , μ_{z} into one feature value μ, where μ=(μ₁, μ₂, . . . , μ_{z}), and μ represents a channel statistics descriptor after global average pooling is performed on the first feature map.

In this way, it can be learned that, because the electronic device can perform feature aggregation processing on the N target feature matrices by using the second pooling layer, to obtain the N third feature values, that is, obtain N relatively simple third feature values, the electronic device can perform temporal modeling on the N relatively simple third feature values by using the LSTM layer, instead of performing temporal modeling on N relatively complex target feature matrices, so that a calculation amount of the LSTM layer can be reduced. Therefore, power consumption of the electronic device can be reduced.

Step 104: The electronic device outputs the voice activity detection category based on the second feature map.

In this embodiment of this application, the voice activity detection category is used to indicate that the target audio signal is a speech signal or a non-speech signal.

Optionally, in this embodiment of this application, the electronic device may obtain two feature values through calculation based on the second feature map, where one of the two feature values is used to represent a probability that the target audio signal is a speech signal, and the other is used to represent a probability that the target audio signal is a non-speech signal, so that the electronic device can determine, based on the two feature values, that the target audio signal is a speech signal or a non-speech signal, and determine the voice activity detection category.

In this embodiment of this application, after obtaining the target audio feature, the electronic device may input the target audio feature into the target model, to extract the feature of the target audio signal through the first network layer and the second network layer, that is, the feature of the target audio signal can be extracted layer by layer. In this way, a representation of the target audio feature in an original feature space is subjected to a plurality of nonlinear mapping transformations by the first network layer and the second network layer into a new feature domain, so that the second feature map can have good robustness and distinguishability. In addition, when the target audio signal is relatively complex, a powerful modeling capability of a deep neural network (that is, the target model) may also be used to describe the feature of the target audio signal well, so that the deep neural network can proper deal with various complex application environments. Therefore, the electronic device can accurately determine, based on the second feature map, that the target audio signal is a speech signal or a non-speech signal, to accurately output the voice activity detection category.

According to the voice activity detection method provided in this embodiment of this application, the electronic device may first obtain the target audio feature of the target audio signal, and then input the target audio feature into the first network layer of the target model, so that the first network layer can perform high-level feature extraction on the target audio feature to obtain the N target feature matrices, so as to obtain the first feature map (the first feature map includes the N first channels, and each first channel includes one target feature matrix). In this way, the electronic device may input the first feature map into the second network layer of the target model, so that the second network layer can perform temporal modeling on each target feature matrix of the first feature map to obtain the N target feature values (each target feature value is used to represent the context feature of the corresponding target feature matrix), so as to obtain the second feature map (the second feature map includes the N second channels, and each second channel includes one target feature value). Therefore, the electronic device can output the voice activity detection category based on the second feature map. Because the electronic device can input the target audio feature of the target audio signal into the target model, the first network layer can perform high-level feature extraction on the target audio feature to obtain the N target feature matrices with higher dimensions, that is, obtain the N target feature matrices with higher robustness and distinguishability, and the second network layer can perform temporal modeling on the N target feature matrices, to obtain the N target feature values used to represent the context features of the N target feature matrices, that is, obtain the N target feature values with higher robustness and distinguishability. In this way, the electronic device can accurately distinguish the target audio signal as a speech signal or a non-speech signal based on the N target feature values with higher robustness and distinguishability, instead of distinguishing the target audio signal as a speech signal or a non-speech signal based on a time domain feature and a frequency domain feature with lower robustness and distinguishability, thereby improving accuracy of voice activity detection performed by the electronic device.

Certainly, a linear layer may also be arranged in the target model to map the second feature map to another space, in which the electronic device can easily determine that the target audio signal is a speech signal or a non-speech signal. The following uses an example for description.

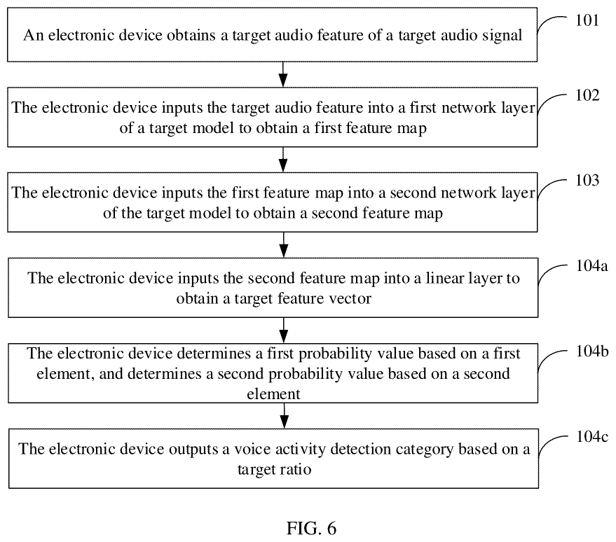

Optionally, in this embodiment of this application, the target model further includes a linear layer. With reference to FIG. 1, as shown in FIG. 6, the foregoing step 104 may be implemented by the following step 104a to step 104c.

Step 104a: The electronic device inputs the second feature map into the linear layer to obtain a target feature vector.

In this embodiment of this application, the target feature vector includes a first element and a second element.

In this embodiment of this application, the first element is used to represent a score that the target audio signal is a speech signal, and the second element is used to represent a score that the target audio signal is a non-speech signal.

In this embodiment of this application, the linear layer is used to map N target feature values of the second feature map to a two-dimensional space.

In this embodiment of this application, the linear layer may use a sixth algorithm to obtain the target feature vector through calculation based on the N target feature values.

The sixth algorithm may be: Y=A×X+B.

Herein, A is a weight matrix, B is a bias matrix, and X is the N target feature values.

Step 104b: The electronic device determines a first probability value based on the first element, and determines a second probability value based on the second element.

In this embodiment of this application, the first probability value is a probability value that the target audio signal is a speech signal, and the second probability value is a probability value that the target audio signal is a non-speech signal.

In this embodiment of this application, the target model may further include a Softmax layer, so that the electronic device can input the target feature vector into the Softmax layer to obtain a first feature vector, where the first feature vector includes the first probability value and the second probability value.

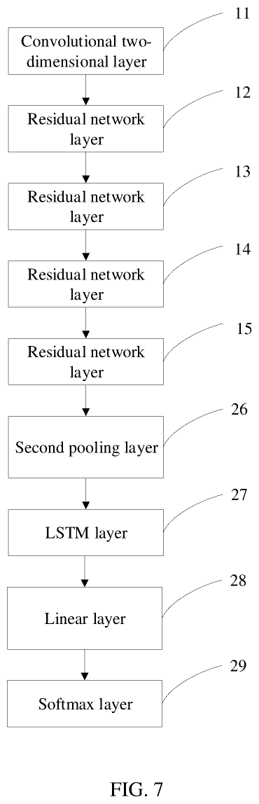

For example, with reference to FIG. 5, as shown in FIG. 7, the target model may further include a linear layer 28 and a Softmax layer 29. An input layer of the linear layer 28 is connected to an output layer of the LSTM layer 27, and an output layer of the linear layer 28 is connected to an input layer of the Softmax layer 29, so that the electronic device can input the second feature map to the linear layer 28 to obtain the first feature vector output by the Softmax layer 29.

Step 104c: The electronic device outputs the voice activity detection category based on a target ratio.

In this embodiment of this application, the target ratio is a ratio of the first probability value to the second probability value.

In this embodiment of this application, the electronic device may determine the voice activity detection category based on a magnitude relationship between the target ratio and a preset threshold.

In this embodiment of this application, in a case that the target ratio is greater than the preset threshold, the voice activity detection category is used to indicate that the target audio signal is a speech signal.

It may be understood that if the target ratio is greater than the preset threshold, the first probability value may be considered to be much greater than the second probability value. Therefore, the voice activity detection category is used to indicate that the target audio signal is a speech signal.

In this embodiment of this application, in a case that the target ratio is less than or equal to the preset threshold, the voice activity detection category is used to indicate that the target audio signal is a non-speech signal.

It may be understood that if the target ratio is less than or equal to the preset threshold, the first probability value may be considered to be much less than the second probability value. Therefore, the voice activity detection category is used to indicate that the target audio signal is a non-speech signal.

In this way, it can be learned that, the electronic device may map the second feature map to the two-dimensional space through the linear layer of the target model (in this two-dimensional space, the electronic device may easily determine that the target audio signal is a speech signal or a non-speech signal). Therefore, the electronic device can accurately determine the first probability value based on the first element and accurately determine the second probability value based on the second element, thereby improving accuracy of determining, by the electronic device, that the target audio signal is a speech signal or a non-speech signal. In this way, accuracy of voice activity detection performed by the electronic device can be improved.

The following uses an example to describe the process of obtaining the target audio feature by the electronic device.

It should be noted that in this embodiment, the target audio signal is a frame of audio signal in the foregoing audio signal, and the electronic device can extract audio features of the target audio signal and audio signals adjacent to the target audio signal to obtain the target audio feature. Details are described below.

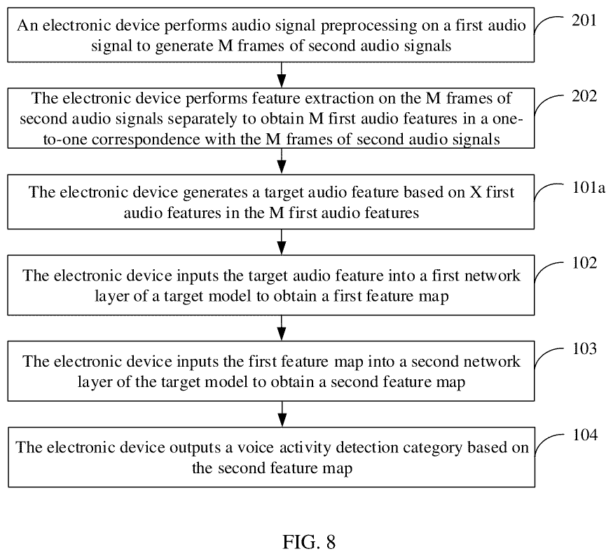

Optionally, in this embodiment of this application, with reference to FIG. 1, as shown in FIG. 8, before the foregoing step 101, the voice activity detection method provided in this embodiment of this application may further include the following step 201 and step 202, and the foregoing step 101 may be implemented by the following step 101a.

Step 201: The electronic device performs audio signal preprocessing on a first audio signal to generate M frames of second audio signals.

It may be understood that the first audio signal may be the foregoing audio signal, that is, the audio signal to be transmitted by the electronic device.

In this embodiment of this application, the M frames of second audio signals include the target audio signal, and M is a positive integer.

It may be understood that the target audio signal is any one of the M frames of second audio signals.

In this embodiment of this application, the electronic device may first perform pre-emphasis processing on the first audio signal first, and then perform framing processing on the first audio signal after pre-emphasis processing, to obtain M frames of third audio signals, so that the electronic device can perform windowing processing on the M frames of third audio signals to perform audio signal preprocessing on the first audio signal, so as to generate the M frames of second audio signals.

In this embodiment of this application, the electronic device may use a seventh algorithm to perform pre-emphasis processing on the first audio signal.

The seventh algorithm may be y(n)=x(n)−a×x(n−1).

Herein, y(n) is the first audio signal after pre-emphasis processing, x(n) is an n^{th} frame of audio signal in the first audio signal, and a is a constant.

For example, a may be greater than 0.9 and less than 1.0. For example, a may be 0.97.

In this embodiment of this application, the electronic device may use a Hamming window to perform windowing processing on the M frames of third audio signals to generate the M frames of second audio signals.

Step 202: The electronic device performs feature extraction on the M frames of second audio signals respectively to obtain M first audio features in a one-to-one correspondence with the M frames of second audio signals.

In this embodiment of this application, the first audio feature may include at least one of the following: an Fbank feature, an MFCC feature, a PLP feature, or an FFT spectral feature.

In a case that the first audio feature includes the Fbank feature, for each of the M frames of second audio signals, the electronic device may first transform one frame of second audio signal by using a fast Fourier transform algorithm, to obtain a signal spectrum corresponding to the frame of second audio signal, then calculate frequency energy of each frequency in the signal spectrum, perform Mel filtering on a frequency capability obtained through calculation, and obtain a logarithm of a subband capability obtained through Mel filtering, so as to obtain one first audio feature corresponding to the frame of second audio signal, and so on, to obtain the M first audio features.

Step 101a: The electronic device generates the target audio feature based on X first audio features in the M first audio features.

In this embodiment of this application, the X first audio features include a first audio feature corresponding to the target audio signal and Y first audio features, where Y is a positive integer less than X; and the Y first audio features include at least one of the following: i frames of audio signals previous to the target audio signal in the M frames of second audio signals or j frames of audio signals subsequent to the target audio signal in the M frames of second audio signals, where i is a positive integer, j is an integer greater than or equal to 0, and X is a positive integer less than or equal to M.

It may be understood that when j is 0, the Y first audio features include the i frames of audio signals previous to the target audio signal in the M frames of second audio signals.

In this embodiment of this application, the electronic device may perform frame concatenation processing on the X first audio features to obtain the target audio feature.

For example, assuming that the X first audio features include eight audio features, such as a first audio feature Fbₜ(m) corresponding to the target audio signal, a first audio feature Fbₜ₊₁(m) corresponding to a frame of audio signal subsequent to the target audio signal, and first audio features Fbₜ₋₁(m)-Fbₜ₋₇(m) corresponding to seven frames of audio signals previous to the target audio signal, the electronic device may perform frame concatenation processing on Fbₜ(m), Fbₜ₊₁(m), and Fbₜ₋₁(m)-Fbₜ₋₇(m), to obtain the target audio feature.

In this way, it can be learned that, because the electronic device can split the first audio signal into the M frames of second audio signals and extract the M first audio features of the M frames of second audio signals separately, the electronic device can generate the target audio feature based on the first audio feature corresponding to the target audio signal and the first audio features corresponding to the i frames of audio signals previous to the target audio signal (and/or the j frames of audio signals subsequent to the target audio signal), that is, the target audio feature combines context information of the target audio signal. Therefore, the electronic device can accurately determine, based on the target audio feature, whether the target audio signal is a speech signal or a non-speech signal.

It should be noted that after the electronic device generates the target audio feature and performs the foregoing step 101 to step 104 to determine that the target audio signal is a speech signal or a non-speech signal, the electronic device may perform step 201, step 202, and step 101a again for a frame of audio signal next to the target audio signal to generate an audio feature of the next frame of audio signal, and perform the foregoing step 101 to step 104 again to determine that the next frame of audio signal is a speech signal or a non-speech signal, and so on, to determine that each frame of audio signal in the M frames of second audio signals is a speech signal or a non-speech signal.

Certainly, after outputting the voice activity detection category, the electronic device may further perform different operations based on different voice activity detection categories, to reduce an amount of transmitted audio data or reduce energy consumption of the electronic device. The following uses an example for description.

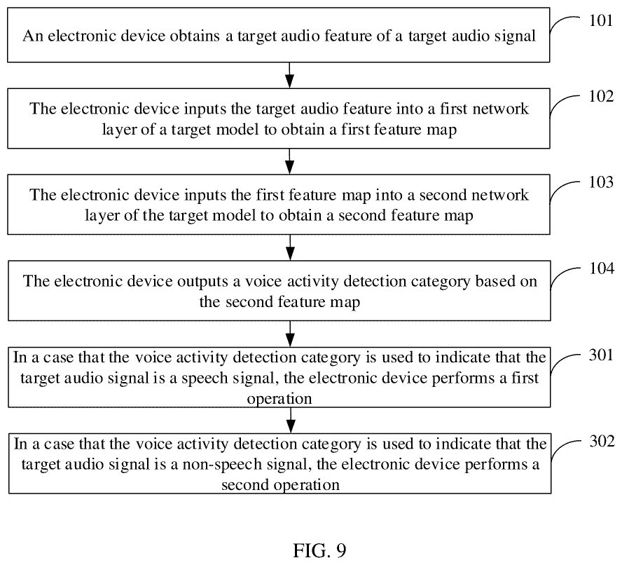

Optionally, in this embodiment of this application, with reference to FIG. 1, as shown in FIG. 9, after the foregoing step 104, the voice activity detection method provided in this embodiment of this application may further include the following step 301 and step 302.

Step 301: In a case that the voice activity detection category is used to indicate that the target audio signal is a speech signal, the electronic device performs a first operation.

In this embodiment of this application, the first operation includes at least one of the following: encoding the target audio signal in a first encoding mode or inputting the target audio signal into a speech recognition engine.

In this embodiment of this application, a number of encoded bits corresponding to the first encoding mode is greater than a number of encoded bits corresponding to another encoding mode (for example, a second encoding mode in the following embodiment).

When the electronic device needs to transmit the foregoing audio signal, in a case that the voice activity detection category is used to indicate that the target audio signal is a speech signal, the electronic device may encode the target audio signal in the first encoding mode by using an encoder and transmit the encoded target audio signal.

When the electronic device needs to perform speech recognition on the foregoing audio signal, in a case that the voice activity detection category is used to indicate that the target audio signal is a speech signal, the electronic device may input the target audio signal into the speech recognition engine for speech recognition.

In this way, it can be learned that, because the electronic device can encode the target audio signal in the first encoding mode corresponding to a relatively large number of encoded bits in a case that the voice activity detection category is used to indicate that the target audio signal is a speech signal, audio quality of the target audio signal can be improved; and/or because the electronic device performs speech recognition on the target audio signal only in a case that the voice activity detection category is used to indicate that the target audio signal is a speech signal, the calculation amount can be reduced. Therefore, performance of the electronic device can be improved.

Step 302: In a case that the voice activity detection category is used to indicate that the target audio signal is a non-speech signal, the electronic device performs a second operation.

In this embodiment of this application, the second operation includes at least one of the following: encoding the target audio signal in a second encoding mode or not inputting the target audio signal into the speech recognition engine. The number of encoded bits corresponding to the first encoding mode is greater than a number of encoded bits corresponding to the second encoding mode.

When the electronic device needs to transmit the foregoing audio signal, in a case that the voice activity detection category is used to indicate that the target audio signal is a non-speech signal, the electronic device may control the encoder to start a discontinuous transmission (DTX) mode (that is, the second encoding mode), so as to reduce the corresponding number of encoded bits.

When the electronic device needs to perform speech recognition on the foregoing audio signal, in a case that the voice activity detection category is used to indicate that the target audio signal is a non-speech signal, the electronic device may not input the target audio signal into the speech recognition engine, but discard the target audio signal.

In this way, it can be learned that, because in a case that the voice activity detection category is used to indicate that the target audio signal is a non-speech signal, the electronic device can encode the target audio signal in the second encoding mode corresponding to a relatively small number of encoded bits, a transmitted audio data stream can be reduced; and/or because in a case that the voice activity detection category is used to indicate that the target audio signal is a non-speech signal, the electronic device discards the target audio signal, the calculation amount can be reduced. Therefore, performance of the electronic device can be improved.

The voice activity detection method provided in the embodiments of this application may be performed by a voice activity detection apparatus. A voice activity detection apparatus provided in the embodiments of this application is described by assuming that the voice activity detection method in the embodiments of this application is performed by the voice activity detection apparatus.

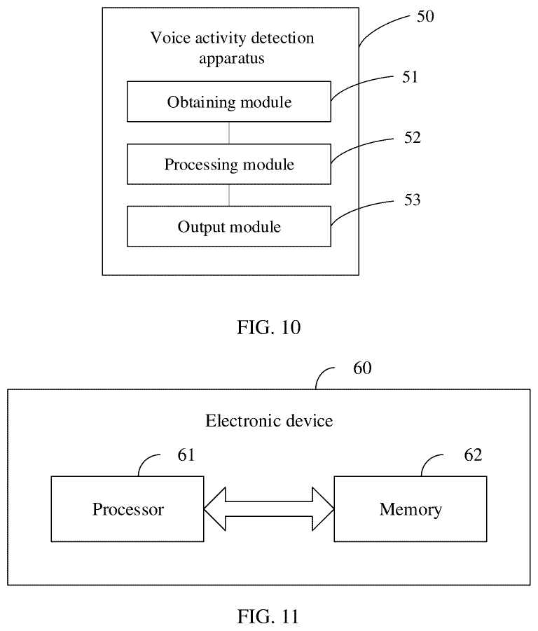

FIG. 10 is a schematic diagram of a possible structure of a voice activity detection apparatus according to an embodiment of this application. As shown in FIG. 10, the voice activity detection apparatus 50 may include an obtaining module 51, a processing module 52, and an output module 53.

The obtaining module 51 is configured to obtain a target audio feature of a target audio signal. The processing module 52 is configured to: input the target audio feature obtained by the obtaining module 51 into a first network layer of a target model to obtain a first feature map, where the first feature map includes N first channels, each first channel includes one target feature matrix, each target feature matrix is obtained by the first network layer by performing high-level feature extraction on the target audio feature, and N is a positive integer greater than 1; and input the first feature map into a second network layer of the target model to obtain a second feature map, where the second feature map includes N second channels, each second channel corresponds to one first channel, each second channel includes one target feature value, each target feature value is obtained by the second network layer by performing temporal modeling on a corresponding target feature matrix, and each target feature value is used to represent a context feature of the corresponding target feature matrix. The output module 53 is configured to output a voice activity detection category based on the second feature map obtained by the processing module 52 after the input.

In a possible implementation, the processing module 52 is further configured to: perform audio signal preprocessing on a first audio signal to generate M frames of second audio signals, where the M frames of second audio signals include the target audio signal, and M is a positive integer; and perform feature extraction on the M frames of second audio signals respectively to obtain M first audio features in a one-to-one correspondence with the M frames of second audio signals. The obtaining module 51 is configured to generate the target audio feature based on X first audio features in the M first audio features obtained by the processing module 52 through processing, where X is a positive integer less than or equal to M, where the X first audio features include a first audio feature of the target audio signal and Y first audio features, where Y is a positive integer less than X; and the Y first audio features include at least one of the following: i frames of audio signals previous to the target audio signal in the M frames of second audio signals or j frames of audio signals subsequent to the target audio signal in the M frames of second audio signals, where i is a positive integer and j is an integer greater than or equal to 0.

In a possible implementation, the first network layer includes a CNN layer. The processing module 52 is configured to: input the target audio feature into the CNN layer to obtain a third feature map, where the third feature map includes Q third channels, each third channel includes one first feature matrix, each first feature matrix is obtained by the CNN layer by performing a convolution operation on the target audio feature, and Q is a positive integer greater than 1; and obtain the first feature map based on the third feature map.

In a possible implementation, the first network layer further includes at least one residual network layer connected in sequence. The processing module 52 is configured to input the third feature map into the at least one residual network layer to obtain the first feature map, where the first feature map is obtained by the at least one residual network layer by sequentially performing an operation on the third feature map, and a network hyperparameter of each residual network layer is different.

In a possible implementation, a first residual network layer includes a residual network and an SE unit, and the first residual network layer is any one of the at least one residual network layer. The processing module 52 is configured to: input a fourth feature map into the residual network to obtain a fifth feature map, where the fourth feature map is a feature map output by a residual network layer previous to the first residual network layer in the at least one residual network layer; input the fifth feature map into the SE unit to obtain a first weight value, where the first weight value includes a second weight value corresponding to each channel included in the fifth feature map, and each second weight value is used to represent a weight of a corresponding channel for audio signal classification; then generate a sixth feature map based on the fifth feature map and the first weight value; and obtain a seventh feature map based on the fourth feature map and the sixth feature map, and output the seventh feature map, where the seventh feature map is a feature map input by a residual network layer next to the first residual network layer in the at least one residual network layer.

In a possible implementation, the fifth feature map includes Z fourth channels, each fourth channel includes one second feature matrix, each second feature matrix is obtained by the residual network by performing an operation on the fourth feature map, the SE unit includes a first pooling layer and a fully connected layer that are connected to each other, and Z is a positive integer greater than 1. The processing module 52 is configured to: input Z second feature matrices into the first pooling layer to obtain Z first feature values, where each first feature value is obtained by the first pooling layer by performing an operation on one second feature matrix; and input the Z first feature values into the fully connected layer to obtain Z second weight values, where each second weight value is obtained by the fully connected layer by performing an operation on one first feature value, and the first weight value includes the Z second weight values.

In a possible implementation, the second network layer includes an LSTM layer. The processing module 52 is configured to input N third feature values into the LSTM layer to obtain N target feature values, where each target feature value is obtained by the LSTM layer by performing temporal modeling on one third feature value, where the N third feature values are in a one-to-one correspondence with N target feature matrices, and each third feature value is obtained by performing feature aggregation processing on a corresponding target feature matrix.

In a possible implementation, the second network layer further includes a second pooling layer. The processing module 52 is further configured to input the N target feature matrices into the second pooling layer to obtain the N third feature values, where each third feature value is obtained by the second pooling layer by performing feature aggregation processing on one target feature matrix.

In a possible implementation, the target model further includes a linear layer. The output module 53 includes a first processing submodule and a first output submodule, where the first processing submodule is configured to input the second feature map into the linear layer to obtain a target feature vector, where the target feature vector includes a first element and a second element; and the first output submodule is configured to: determine a first probability value based on the first element, and determine a second probability value based on the second element, where the first probability value is a probability value that the target audio signal is a speech signal, and the second probability value is a probability value that the target audio signal is a non-speech signal; and output the voice activity detection category based on a target ratio, where the target ratio is a ratio of the first probability value to the second probability value; and in a case that the target ratio is greater than a preset threshold, the voice activity detection category is used to indicate that the target audio signal is a speech signal; or in a case that the target ratio is less than or equal to a preset threshold, the voice activity detection category is used to indicate that the target audio signal is a non-speech signal.

In a possible implementation, the voice activity detection apparatus provided in this embodiment of this application may further include an execution module. The execution module is configured to: in a case that the voice activity detection category is used to indicate that the target audio signal is a speech signal, perform a first operation; or in a case that the voice activity detection category is used to indicate that the target audio signal is a non-speech signal, perform a second operation, where the first operation includes at least one of the following: encoding the target audio signal in a first encoding mode or inputting the target audio signal into a speech recognition engine; and the second operation includes at least one of the following: encoding the target audio signal in a second encoding mode or not inputting the target audio signal into the speech recognition engine; and a number of encoded bits corresponding to the first encoding mode is greater than a number of encoded bits corresponding to the second encoding mode.

According to the voice activity detection apparatus provided in this embodiment of this application, because the voice activity detection apparatus can input the target audio feature of the target audio signal into the target model, the first network layer can perform high-level feature extraction on the target audio feature to obtain the N target feature matrices with higher dimensions, that is, obtain the N target feature matrices with higher robustness and distinguishability, and the second network layer can perform temporal modeling on the N target feature matrices, to obtain the N target feature values used to represent context features of the N target feature matrices, that is, obtain the N target feature values with higher robustness and distinguishability. In this way, the voice activity detection apparatus can accurately distinguish the target audio signal as a speech signal or a non-speech signal based on the N target feature values with higher robustness and distinguishability, instead of distinguishing the target audio signal as a speech signal or a non-speech signal based on a time domain feature and a frequency domain feature with lower robustness and distinguishability, thereby improving accuracy of voice activity detection performed by the voice activity detection apparatus.

The voice activity detection apparatus in this embodiment of this application may be an electronic device, or may be a component such as an integrated circuit or a chip in an electronic device. The electronic device may be a terminal, or may be other devices than a terminal. For example, the electronic device may be a mobile phone, a tablet personal computer, a notebook computer, a palmtop computer, an in-vehicle electronic device, a mobile Internet device (MID), an augmented reality (AR) or virtual reality (VR) device, a robot, a wearable device, an ultra-mobile personal computer (UMPC), a netbook, a personal digital assistant (PDA), or the like; or the electronic device may be a server, a network attached storage (NAS), a personal computer (PC), a television (TV), a teller machine, a self-service machine, or the like. This is not limited in this embodiment of this application.

The voice activity detection apparatus in this embodiment of this application may be an apparatus having an operating system. The operating system may be an Android operating system, an iOS operating system, or other possible operating systems, and is not limited in this embodiment of this application.

The voice activity detection apparatus provided in this embodiment of this application is capable of implementing the processes implemented in the method embodiments in FIG. 1 to FIG. 9. To avoid repetition, details are not described herein again.

Optionally, in an embodiment of this application, as shown in FIG. 11, an embodiment of this application further provides an electronic device 60, including a processor 61 and a memory 62. The memory 62 stores a program or instructions executable on the processor 61. When the program or instructions are executed by the processor 61, the steps of the foregoing embodiment of the voice activity detection method are implemented, with the same technical effect achieved. To avoid repetition, details are not described herein again.

It should be noted that electronic devices in this embodiment of this application include the foregoing mobile electronic device and a nonmobile electronic device.

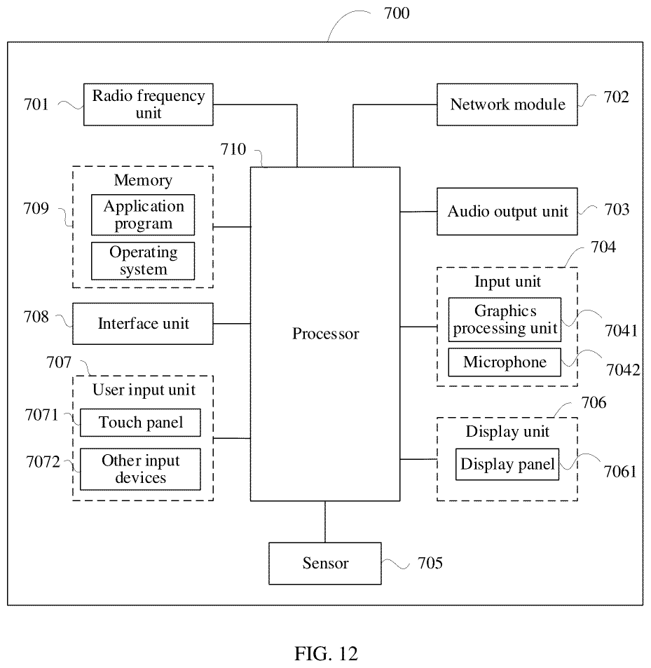

FIG. 12 is a schematic diagram of a hardware structure of an electronic device for implementing an embodiment of this application.

The electronic device 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

A person skilled in the art may understand that the electronic device 700 may further include a power supply (such as a battery) for supplying power to the components. The power supply may be logically connected to the processor 710 through a power management system. In this way, functions such as charge management, discharge management, and power consumption management are implemented by using the power management system. The structure of the electronic device shown in FIG. 12 does not constitute a limitation on the electronic device. The electronic device may include more or fewer components than those shown in the figure, or some components are combined, or component arrangements are different. Details are not described herein again.

The processor 710 is configured to: obtain a target audio feature of a target audio signal; input the target audio feature into a first network layer of a target model to obtain a first feature map, where the first feature map includes N first channels, each first channel includes one target feature matrix, each target feature matrix is obtained by the first network layer by performing high-level feature extraction on the target audio feature, and N is a positive integer greater than 1; input the first feature map into a second network layer of the target model to obtain a second feature map, where the second feature map includes N second channels, each second channel corresponds to one first channel, each second channel includes one target feature value, each target feature value is obtained by the second network layer by performing temporal modeling on a corresponding target feature matrix, and each target feature value is used to represent a context feature of the corresponding target feature matrix; and output a voice activity detection category based on the second feature map.

According to the electronic device provided in this embodiment of this application, because the electronic device can input the target audio feature of the target audio signal into the target model, the first network layer can perform high-level feature extraction on the target audio feature to obtain N target feature matrices with higher dimensions, that is, obtain the N target feature matrices with higher robustness and distinguishability, and the second network layer can perform temporal modeling on the N target feature matrices, to obtain N target feature values used to represent context features of the N target feature matrices, that is, obtain the N target feature values with higher robustness and distinguishability. In this way, the electronic device can accurately distinguish the target audio signal as a speech signal or a non-speech signal based on the N target feature values with higher robustness and distinguishability, instead of distinguishing the target audio signal as a speech signal or a non-speech signal based on a time domain feature and a frequency domain feature with lower robustness and distinguishability, thereby improving accuracy of voice activity detection performed by the electronic device.

Optionally, in this embodiment of this application, the processor 710 is further configured to: perform audio signal preprocessing on a first audio signal to generate M frames of second audio signals, where the M frames of second audio signals include the target audio signal, and M is a positive integer; and perform feature extraction on the M frames of second audio signals respectively to obtain M first audio features in a one-to-one correspondence with the M frames of second audio signals.

The processor 710 is configured to generate the target audio feature based on X first audio features in the M first audio features, where X is a positive integer less than or equal to M, where the X first audio features include a first audio feature of the target audio signal and Y first audio features, where Y is a positive integer less than X; and the Y first audio features include at least one of the following: i frames of audio signals previous to the target audio signal in the M frames of second audio signals or j frames of audio signals subsequent to the target audio signal in the M frames of second audio signals, where i is a positive integer and j is an integer greater than or equal to 0.

In this way, it can be learned that, because the electronic device can split the first audio signal into the M frames of second audio signals and extract the M first audio features of the M frames of second audio signals separately, the electronic device can generate the target audio feature based on the first audio feature corresponding to the target audio signal and the first audio features corresponding to the i frames of audio signals previous to the target audio signal (and/or the j frames of audio signals subsequent to the target audio signal), that is, the target audio feature combines context information of the target audio signal. Therefore, the electronic device can accurately determine, based on the target audio feature, whether the target audio signal is a speech signal or a non-speech signal.

Optionally, in this embodiment of this application, the first network layer includes a CNN layer.

The processor 710 is configured to: input the target audio feature into the CNN layer to obtain a third feature map, where the third feature map includes Q third channels, each third channel includes one first feature matrix, each first feature matrix is obtained by the CNN layer by performing a convolution operation on the target audio feature, and Q is a positive integer greater than 1; and obtain the first feature map based on the third feature map.

In this way, it can be learned that, because the electronic device can input the target audio feature into the CNN layer to increase the number of channels corresponding to the target audio feature, the third feature map with higher dimensions can be obtained, that is, the third feature map with higher robustness can be obtained. Therefore, the electronic device can obtain the first feature map with higher robustness based on the third feature map. This can reduce impact of noise on the first feature map when the electronic device is in an environment with a low signal-to-noise ratio. In this way, the electronic device can accurately distinguish a speech signal from a non-speech signal based on the first feature map.

Optionally, in this embodiment of this application, the first network layer further includes at least one residual network layer connected in sequence.

The processor 710 is configured to input the third feature map into the at least one residual network layer to obtain the first feature map, where
the first feature map is obtained by the at least one residual network layer by sequentially performing an operation on the third feature map, and a network hyperparameter of each residual network layer is different.

In this way, it can be learned that, because at least one residual network layer may be arranged in the first network layer, a problem of network degradation caused by the target model having more network layers can be avoided, and performance degradation of the target model can be avoided.

Optionally, in this embodiment of this application, the first residual network layer includes a residual network and an SE unit; and the first residual network layer is any one of at least one residual network layer.

The processor 710 is configured to:
input a fourth feature map into the residual network to obtain a fifth feature map, where the fourth feature map is a feature map output by a residual network layer previous to the first residual network layer in the at least one residual network layer; then input the fifth feature map into the SE unit to obtain a first weight value, where the first weight value includes a second weight value corresponding to each channel included in the fifth feature map, and each second weight value is used to represent a weight of a corresponding channel for audio signal classification; generate a sixth feature map based on the fifth feature map and the first weight value; and obtain a seventh feature map based on the fourth feature map and the sixth feature map, and output the seventh feature map, where the seventh feature map is a feature map input by a residual network layer next to the first residual network layer in the at least one residual network layer.

In this way, it can be learned that, because the SE unit may also be arranged in the first residual network, the SE unit can be used to obtain a second weight value corresponding to each channel of the fifth feature map, to determine the weight of each channel for audio signal classification in the fifth feature map; and based on the weight of each channel in the fifth feature map, a feature of a useful channel for audio signal classification in the fourth feature map can be amplified, and a feature of a useless channel for audio signal classification in the fourth feature map can be suppressed. Therefore, the feature representation capability of the obtained first feature map can be improved. In this way, the electronic device can accurately output the voice activity detection category based on the first feature map.

Optionally, in this embodiment of this application, the fifth feature map includes Z fourth channels, each fourth channel includes one second feature matrix, each second feature matrix is obtained by the residual network by performing an operation on the fourth feature map, the SE unit includes a first pooling layer and a fully connected layer that are connected to each other, and Z is a positive integer greater than 1.

The processor 710 is configured to: input Z second feature matrices into the first pooling layer to obtain Z first feature values, where each first feature value is obtained by the first pooling layer by performing an operation on one second feature matrix; and input the Z first feature values into the fully connected layer to obtain Z second weight values, where each second weight value is obtained by the fully connected layer by performing an operation on one first feature value, and the first weight value includes the Z second weight values.

In this way, it can be learned that, because the electronic device can input the Z second feature matrices into the first pooling layer and input the Z first feature values output by the first pooling layer into the fully connected layer to obtain the Z second weight values used to represent weights of the Z fourth channels of the fifth feature map for audio signal classification, the electronic device can amplify a feature of a useful channel for audio signal classification in the fourth feature map and suppress a feature of a useless channel for audio signal classification in the fourth feature map based on the Z second weight values. Therefore, the feature representation capability of the obtained first feature map can be improved. In this way, the electronic device can accurately output a voice activity detection category based on the first feature map.

Optionally, in this embodiment of this application, the second network layer includes an LSTM layer.

The processor 710 is configured to input N third feature values into the LSTM layer to obtain N target feature values, where each target feature value is obtained by the LSTM layer by performing temporal modeling on one third feature value, where
the N third feature values are in a one-to-one correspondence with N target feature matrices, and each third feature value is obtained by performing feature aggregation processing on a corresponding target feature matrix.

In this way, it can be learned that, because the electronic device can perform temporal modeling on the N third feature values by using the LSTM layer, and obtain the N target feature values used to represent the context features of the N target feature matrices, so as to obtain the second feature map, instead of assuming stationarity of noise, the second feature map still has good robustness and distinguishability in an environment with non-stationary noise (such as an environment with a low signal-to-noise ratio), that is, the electronic device can accurately output the voice activity detection category based on the second feature map.

Optionally, in this embodiment of this application, the second network layer further includes a second pooling layer.

The processor 710 is further configured to input the N target feature matrices into the second pooling layer to obtain the N third feature values, where each third feature value is obtained by the second pooling layer by performing feature aggregation processing on one target feature matrix.

In this way, it can be learned that, because the electronic device can perform feature aggregation processing on the N target feature matrices by using the second pooling layer, to obtain the N third feature values, that is, obtain N relatively simple third feature values, the electronic device can perform temporal modeling on the N relatively simple third feature values by using the LSTM layer, instead of performing temporal modeling on N relatively complex target feature matrices, so that a calculation amount of the LSTM layer can be reduced. Therefore, power consumption of the electronic device can be reduced.

Optionally, in this embodiment of this application, the target model further includes a linear layer.

The processor 710 is configured to: input the second feature map into the linear layer to obtain a target feature vector, where the target feature vector includes a first element and a second element; determine a first probability value based on the first element, and determine a second probability value based on the second element, where the first probability value is a probability value that the target audio signal is a speech signal, and the second probability value is a probability value that the target audio signal is a non-speech signal; and output the voice activity detection category based on a target ratio, where
the target ratio is a ratio of the first probability value to the second probability value; and in a case that the target ratio is greater than a preset threshold, the voice activity detection category is used to indicate that the target audio signal is a speech signal; or in a case that the target ratio is less than or equal to a preset threshold, the voice activity detection category is used to indicate that the target audio signal is a non-speech signal.

In this way, it can be learned that, the electronic device may map the second feature map to the two-dimensional space through the linear layer of the target model (in this two-dimensional space, the electronic device may easily determine that the target audio signal is a speech signal or a non-speech signal). Therefore, the electronic device can accurately determine the first probability value based on the first element and accurately determine the second probability value based on the second element, thereby improving accuracy of determining, by the electronic device, that the target audio signal is a speech signal or a non-speech signal. In this way, accuracy of voice activity detection performed by the electronic device can be improved.

Optionally, in this embodiment of this application, the processor 710 is further configured to: in a case that the voice activity detection category is used to indicate that the target audio signal is a speech signal, perform a first operation; or in a case that the voice activity detection category is used to indicate that the target audio signal is a non-speech signal, perform a second operation, where
the first operation includes at least one of the following: encoding the target audio signal in a first encoding mode or inputting the target audio signal into a speech recognition engine; and the second operation includes at least one of the following: encoding the target audio signal in a second encoding mode or not inputting the target audio signal into the speech recognition engine; and a number of encoded bits corresponding to the first encoding mode is greater than a number of encoded bits corresponding to the second encoding mode.

In this way, it can be learned that, because the electronic device can encode the target audio signal in the first encoding mode corresponding to a relatively large number of encoded bits in a case that the voice activity detection category is used to indicate that the target audio signal is a speech signal, audio quality of the target audio signal can be improved; and/or because the electronic device performs speech recognition on the target audio signal only in a case that the voice activity detection category is used to indicate that the target audio signal is a speech signal, the calculation amount can be reduced. Therefore, performance of the electronic device can be improved.

In this way, it can be learned that, because in a case that the voice activity detection category is used to indicate that the target audio signal is a non-speech signal, the electronic device can encode the target audio signal in the second encoding mode corresponding to a relatively small number of encoded bits, a transmitted audio data stream can be reduced; and/or because in a case that the voice activity detection category is used to indicate that the target audio signal is a non-speech signal, the electronic device discards the target audio signal, the calculation amount can be reduced. Therefore, performance of the electronic device can be improved.

It should be understood that, in this embodiment of this application, the input unit 704 may include a graphics processing unit (GPU) 7041 and a microphone 7042. The graphics processing unit 7041 processes image data of a still picture or a video obtained by an image capture apparatus (such as a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 or other input devices 7072. The touch panel 7071 is also referred to as a touchscreen. The touch panel 7071 may include two parts: a touch detection apparatus and a touch controller. The other input devices 7072 may include but are not limited to a physical keyboard, a function button (such as a volume control button or a power button), a trackball, a mouse, and a joystick. Details are not described herein again.

The memory 709 may be configured to store software programs and various data. The memory 709 may primarily include a first storage area for storing programs or instructions and a second storage area for storing data. The first storage area may store an operating system, an application program or instructions required by at least one function (such as an audio play function and an image play function), and the like. In addition, the memory 709 may include a volatile memory or a non-volatile memory, or the memory 709 may include both a volatile memory and a non-volatile memory. The non-volatile memory may be a read-only memory (ROM), a programmable read-only memory (PROM), an erasable programmable read-only memory (EPROM), and an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DRRAM). The memory 709 in this embodiment of this application includes but is not limited to these and any other suitable types of memories.

The processor 710 may include one or more processing units. Optionally, the processor 710 integrates an application processor and a modem processor. The application processor mainly processes operations related to the operating system, a user interface, an application program, and the like. The modem processor mainly processes a wireless communication signal. For example, the modem processor is a baseband processor. It may be understood that the modem processor may alternatively be not integrated in the processor 710.

An embodiment of this application further provides a non-transitory readable storage medium. The non-transitory readable storage medium stores a program or instructions. When the program or instructions are executed by a processor, each process of the foregoing embodiment of the voice activity detection method is implemented, with the same technical effect achieved. To avoid repetition, details are not described herein again.

The processor is a processor in the electronic device in the foregoing embodiment. The non-transitory readable storage medium includes a non-transitory computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the foregoing embodiment of the voice activity detection method, with the same technical effect achieved. To avoid repetition, details are not described herein again.

It should be understood that the chip provided in this embodiment of this application may also be referred to as a system-level chip, a system chip, a chip system, a system-on-chip, or the like.

An embodiment of this application provides a computer program product. The program product is stored in a non-transitory storage medium, and the program product is executed by at least one processor to implement each process of the foregoing embodiment of the voice activity detection method, with the same technical effect achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and certainly may alternatively be implemented by using hardware. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing embodiments. The foregoing embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A voice activity detection method, wherein the method comprises:
obtaining a target audio feature of a target audio signal;
inputting the target audio feature into a first network layer of a target model to obtain a first feature map, wherein the first feature map comprises N first channels, each first channel comprises one target feature matrix, each target feature matrix is obtained by the first network layer by performing high-level feature extraction on the target audio feature, and N is a positive integer greater than 1;
inputting the first feature map into a second network layer of the target model to obtain a second feature map, wherein the second feature map comprises N second channels, each second channel corresponds to one first channel, each second channel comprises one target feature value, each target feature value is obtained by the second network layer by performing temporal modeling on a corresponding target feature matrix, and each target feature value is used to represent a context feature of the corresponding target feature matrix; and
outputting a voice activity detection category based on the second feature map.

2. The method according to claim 1, wherein before the obtaining a target audio feature of a target audio signal, the method further comprises:
performing audio signal preprocessing on a first audio signal to generate M frames of second audio signals, wherein the M frames of second audio signals comprise the target audio signal, and M is a positive integer; and
performing feature extraction on the M frames of second audio signals respectively to obtain M first audio features in a one-to-one correspondence with the M frames of second audio signals; and
the obtaining a target audio feature of a target audio signal comprises:
generating the target audio feature based on X first audio features in the M first audio features, wherein X is a positive integer less than or equal to M, wherein
the X first audio features comprise a first audio feature of the target audio signal and Y first audio features, wherein Y is a positive integer less than X; and
the Y first audio features comprise at least one of the following: i frames of audio signals previous to the target audio signal in the M frames of second audio signals or j frames of audio signals subsequent to the target audio signal in the M frames of second audio signals, wherein i is a positive integer and j is an integer greater than or equal to 0.

3. The method according to claim 1, wherein the first network layer comprises a convolutional neural network (CNN) layer; and
the inputting the target audio feature into a first network layer of a target model to obtain a first feature map comprises:
inputting the target audio feature into the CNN layer to obtain a third feature map, wherein the third feature map comprises Q third channels, each third channel comprises one first feature matrix, each first feature matrix is obtained by the CNN layer by performing a convolution operation on the target audio feature, and Q is a positive integer greater than 1; and
obtaining the first feature map based on the third feature map.

4. The method according to claim 3, wherein the first network layer further comprises at least one residual network layer connected in sequence; and
the obtaining the first feature map based on the third feature map comprises:
inputting the third feature map into the at least one residual network layer to obtain the first feature map, wherein
the first feature map is obtained by the at least one residual network layer by sequentially performing an operation on the third feature map, and a network hyperparameter of each residual network layer is different.

5. The method according to claim 4, wherein a first residual network layer comprises a residual network and a squeeze-and-excitation (SE) unit, and the first residual network layer is any one of the at least one residual network layer; and
the inputting the third feature map into the at least one residual network layer to obtain the first feature map comprises:
inputting a fourth feature map into the residual network to obtain a fifth feature map, wherein the fourth feature map is a feature map output by a residual network layer previous to the first residual network layer in the at least one residual network layer;
inputting the fifth feature map into the SE unit to obtain a first weight value, wherein the first weight value comprises a second weight value corresponding to each channel comprised in the fifth feature map, and each second weight value is used to represent a weight of a corresponding channel for audio signal classification;
generating a sixth feature map based on the fifth feature map and the first weight value; and
obtaining a seventh feature map based on the fourth feature map and the sixth feature map, and outputting the seventh feature map, wherein the seventh feature map is a feature map input by a residual network layer next to the first residual network layer in the at least one residual network layer.

6. The method according to claim 5, wherein the fifth feature map comprises Z fourth channels, each fourth channel comprises one second feature matrix, each second feature matrix is obtained by the residual network by performing an operation on the fourth feature map, the SE unit comprises a first pooling layer and a fully connected layer that are connected to each other, and Z is a positive integer greater than 1; and
the inputting the fifth feature map into the SE unit to obtain a first weight value comprises:
inputting Z second feature matrices into the first pooling layer to obtain Z first feature values, wherein each first feature value is obtained by the first pooling layer by performing an operation on one second feature matrix; and
inputting the Z first feature values into the fully connected layer to obtain Z second weight values, wherein each second weight value is obtained by the fully connected layer by performing an operation on one first feature value, and the first weight value comprises the Z second weight values.

7. The method according to claim 1, wherein the second network layer comprises a long short-term memory (LSTM) layer; and
the inputting the first feature map into a second network layer of the target model to obtain a second feature map comprises:
inputting N third feature values into the LSTM layer to obtain N target feature values, wherein each target feature value is obtained by the LSTM layer by performing temporal modeling on one third feature value, wherein
the N third feature values are in a one-to-one correspondence with N target feature matrices, and each third feature value is obtained by performing feature aggregation processing on a corresponding target feature matrix.

8. The method according to claim 7, wherein the second network layer further comprises a second pooling layer; and
before the inputting N third feature values into the LSTM layer to obtain N target feature values, the method further comprises:
inputting the N target feature matrices into the second pooling layer to obtain the N third feature values, wherein each third feature value is obtained by the second pooling layer by performing feature aggregation processing on one target feature matrix.

9. The method according to claim 1, wherein the target model further comprises a linear layer; and
the outputting a voice activity detection category based on the second feature map comprises:
inputting the second feature map into the linear layer to obtain a target feature vector, wherein the target feature vector comprises a first element and a second element;
determining a first probability value based on the first element, and determining a second probability value based on the second element, wherein the first probability value is a probability value that the target audio signal is a speech signal, and the second probability value is a probability value that the target audio signal is a non-speech signal; and
outputting the voice activity detection category based on a target ratio, wherein
the target ratio is a ratio of the first probability value to the second probability value; and
in a case that the target ratio is greater than a preset threshold, the voice activity detection category is used to indicate that the target audio signal is a speech signal; or in a case that the target ratio is less than or equal to a preset threshold, the voice activity detection category is used to indicate that the target audio signal is a non-speech signal.

10. The method according to claim 1, wherein after the outputting a voice activity detection category based on the second feature map, the method further comprises:
in a case that the voice activity detection category is used to indicate that the target audio signal is a speech signal, performing a first operation; or
in a case that the voice activity detection category is used to indicate that the target audio signal is a non-speech signal, performing a second operation, wherein
the first operation comprises at least one of the following: encoding the target audio signal in a first encoding mode or inputting the target audio signal into a speech recognition engine; and the second operation comprises at least one of the following: encoding the target audio signal in a second encoding mode or not inputting the target audio signal into the speech recognition engine; and
a number of encoded bits corresponding to the first encoding mode is greater than a number of encoded bits corresponding to the second encoding mode.

11. An electronic device, comprising a processor and a memory, wherein the memory stores a program or instructions executable on the processor, and the program or instructions, when executed by the processor, cause the electronic device to perform:
obtaining a target audio feature of a target audio signal;
inputting the target audio feature into a first network layer of a target model to obtain a first feature map, wherein the first feature map comprises N first channels, each first channel comprises one target feature matrix, each target feature matrix is obtained by the first network layer by performing high-level feature extraction on the target audio feature, and N is a positive integer greater than 1;
inputting the first feature map into a second network layer of the target model to obtain a second feature map, wherein the second feature map comprises N second channels, each second channel corresponds to one first channel, each second channel comprises one target feature value, each target feature value is obtained by the second network layer by performing temporal modeling on a corresponding target feature matrix, and each target feature value is used to represent a context feature of the corresponding target feature matrix; and
outputting a voice activity detection category based on the second feature map.

12. The electronic device according to claim 11, wherein the program or instructions, when executed by the processor, cause the electronic device to further perform:
performing audio signal preprocessing on a first audio signal to generate M frames of second audio signals, wherein the M frames of second audio signals comprise the target audio signal, and M is a positive integer; and
performing feature extraction on the M frames of second audio signals respectively to obtain M first audio features in a one-to-one correspondence with the M frames of second audio signals; and
the program or instructions, when executed by the processor, cause the electronic device to perform:
generating the target audio feature based on X first audio features in the M first audio features, wherein X is a positive integer less than or equal to M, wherein
the X first audio features comprise a first audio feature of the target audio signal and Y first audio features, wherein Y is a positive integer less than X; and
the Y first audio features comprise at least one of the following: i frames of audio signals previous to the target audio signal in the M frames of second audio signals or j frames of audio signals subsequent to the target audio signal in the M frames of second audio signals, wherein i is a positive integer and j is an integer greater than or equal to 0.

13. The electronic device according to claim 11, wherein the first network layer comprises a convolutional neural network (CNN) layer; and
the program or instructions, when executed by the processor, cause the electronic device to perform:
inputting the target audio feature into the CNN layer to obtain a third feature map, wherein the third feature map comprises Q third channels, each third channel comprises one first feature matrix, each first feature matrix is obtained by the CNN layer by performing a convolution operation on the target audio feature, and Q is a positive integer greater than 1; and
obtaining the first feature map based on the third feature map.

14. The electronic device according to claim 13, wherein the first network layer further comprises at least one residual network layer connected in sequence; and
the program or instructions, when executed by the processor, cause the electronic device to perform:
inputting the third feature map into the at least one residual network layer to obtain the first feature map, wherein
the first feature map is obtained by the at least one residual network layer by sequentially performing an operation on the third feature map, and a network hyperparameter of each residual network layer is different.

15. The electronic device according to claim 14, wherein a first residual network layer comprises a residual network and a squeeze-and-excitation (SE) unit, and the first residual network layer is any one of the at least one residual network layer; and
the program or instructions, when executed by the processor, cause the electronic device to perform:
inputting a fourth feature map into the residual network to obtain a fifth feature map, wherein the fourth feature map is a feature map output by a residual network layer previous to the first residual network layer in the at least one residual network layer;
inputting the fifth feature map into the SE unit to obtain a first weight value, wherein the first weight value comprises a second weight value corresponding to each channel comprised in the fifth feature map, and each second weight value is used to represent a weight of a corresponding channel for audio signal classification;
generating a sixth feature map based on the fifth feature map and the first weight value; and
obtaining a seventh feature map based on the fourth feature map and the sixth feature map, and outputting the seventh feature map, wherein the seventh feature map is a feature map input by a residual network layer next to the first residual network layer in the at least one residual network layer.

16. The electronic device according to claim 15, wherein the fifth feature map comprises Z fourth channels, each fourth channel comprises one second feature matrix, each second feature matrix is obtained by the residual network by performing an operation on the fourth feature map, the SE unit comprises a first pooling layer and a fully connected layer that are connected to each other, and Z is a positive integer greater than 1; and
the program or instructions, when executed by the processor, cause the electronic device to perform:
inputting Z second feature matrices into the first pooling layer to obtain Z first feature values, wherein each first feature value is obtained by the first pooling layer by performing an operation on one second feature matrix; and
inputting the Z first feature values into the fully connected layer to obtain Z second weight values, wherein each second weight value is obtained by the fully connected layer by performing an operation on one first feature value, and the first weight value comprises the Z second weight values.

17. The electronic device according to claim 11, wherein the second network layer comprises a long short-term memory (LSTM) layer; and
the program or instructions, when executed by the processor, cause the electronic device to perform:
inputting N third feature values into the LSTM layer to obtain N target feature values, wherein each target feature value is obtained by the LSTM layer by performing temporal modeling on one third feature value, wherein
the N third feature values are in a one-to-one correspondence with N target feature matrices, and each third feature value is obtained by performing feature aggregation processing on a corresponding target feature matrix.

18. The electronic device according to claim 17, wherein the second network layer further comprises a second pooling layer; and
the program or instructions, when executed by the processor, cause the electronic device to further perform:
inputting the N target feature matrices into the second pooling layer to obtain the N third feature values, wherein each third feature value is obtained by the second pooling layer by performing feature aggregation processing on one target feature matrix.

19. The electronic device according to claim 11, wherein the target model further comprises a linear layer; and
the program or instructions, when executed by the processor, cause the electronic device to perform:
inputting the second feature map into the linear layer to obtain a target feature vector, wherein the target feature vector comprises a first element and a second element;
determining a first probability value based on the first element, and determining a second probability value based on the second element, wherein the first probability value is a probability value that the target audio signal is a speech signal, and the second probability value is a probability value that the target audio signal is a non-speech signal; and
outputting the voice activity detection category based on a target ratio, wherein
the target ratio is a ratio of the first probability value to the second probability value; and
in a case that the target ratio is greater than a preset threshold, the voice activity detection category is used to indicate that the target audio signal is a speech signal; or in a case that the target ratio is less than or equal to a preset threshold, the voice activity detection category is used to indicate that the target audio signal is a non-speech signal.

20. A non-transitory readable storage medium, wherein the non-transitory readable storage medium stores a program or instructions, and the program or instructions, when executed by a processor of an electronic device, cause the electronic device to perform:
obtaining a target audio feature of a target audio signal;
inputting the target audio feature into a first network layer of a target model to obtain a first feature map, wherein the first feature map comprises N first channels, each first channel comprises one target feature matrix, each target feature matrix is obtained by the first network layer by performing high-level feature extraction on the target audio feature, and N is a positive integer greater than 1;
inputting the first feature map into a second network layer of the target model to obtain a second feature map, wherein the second feature map comprises N second channels, each second channel corresponds to one first channel, each second channel comprises one target feature value, each target feature value is obtained by the second network layer by performing temporal modeling on a corresponding target feature matrix, and each target feature value is used to represent a context feature of the corresponding target feature matrix; and
outputting a voice activity detection category based on the second feature map.
